(19) United States
(12) Patent Application Publication
(10) Pub. No.: US 2012/0137527 A1
(43) Pub. Date: Jun. 7, 2012

(54) GARDEN SHEARS

(75) Inventor: Yao-Chung Huang, FU SHING HSIANG (TW)

(73) Assignee: HO CHENG GARDEN TOOLS CO., LTD, FU SHING HSIANG (TW)

(21) Appl. No.: 12/959,362

(22) Filed: Dec. 2, 2010

(51) Int. Cl. A01G 3/08

(52) U.S. Cl. 30/185

(57) ABSTRACT

A garden shears with a driving mechanism includes two cutter bases, an anvil cooperating with the cutter bases, two supporting plates, a cutter plate, and an operating arm. The two cutter bases face each other to form an accommodating space in which the anvil and the two supporting plates are sandwiched. The anvil is fixed to top sections of the two cutter bases. The cutter plate and the operating arm are sandwiched between the two supporting plates. A roller wheel is disposed in a positioning slot of the cutter blade and sandwiched between restricting holes of the two supporting plates. A pivotal hole of the operating arm is pivotally connected between pivotal holes of the two supporting plates in such a manner that a driving toothed edge of the operating arm is drivingly engaged with a driven rack of the cutter plate. A pull lever is fixed to a fixing portion provided on a lower portion of the cutter plate through an elongate slot of the cutter base.

### BACKGROUND OF THE INVENTION

1. Field of the Invention

The present invention relates to garden shears with a driving mechanism, and in particular to garden shears utilizing the lever principle and a toothed engagement to economize the force needed for performing a pruning action.

2. Description of the Prior Art

Since branches are suspended in midair, garden shears are a better choice for pruning branches rather than a handsaw. Some branches are, however, too thick and may be located at high positions, and as a result garden shears operated with a simple shearing action are unsatisfactory in this situation because the user has to exert a large force for pruning such branches. Thus, manufacturers in this art propose garden shears having a labor-saving mechanism to make the pruning action easier. However, existing garden shears having a labor-saving mechanism have a complicated structure, and so the production and assembly thereof requires significant time and work, which inevitably raises production costs.

In view of the above, the present inventor proposes a novel and practical garden shears based on his expert experience and diligent research.

### SUMMARY OF THE INVENTION

Since the conventional labor-saving garden shears has a complicated structure, the production and assembly thereof requires significant time and effort and production costs are consequently high.

In order to solve the above problems, an objective of the present invention is to provide garden shears with a driving mechanism, which includes two cutter bases, an anvil cooperating with the cutter bases, two supporting plates, a cutter plate, and an operating arm. Each of the two cutter bases is provided with at least two positioning holes near its respective center. The upper portion of the cutter base is formed with a lateral opening and a top section located above the lateral opening. A side of the cutter base opposite to the two positioning holes is formed with a pivotal hole. The lower portion of the cutter base is provided with a connecting section. The connecting section is inserted into a handle and fixed thereto. One of the cutter bases is provided with an elongate slot between the positioning hole and the connecting section. The anvil is fixed between the top sections of the two cutter bases. Each of the two supporting plates is provided with a restricting hole and a pivotal hole. When the restricting hole and the pivotal hole of the supporting plate are aligned with the positioning hole and the pivotal hole of the cutter base, the two supporting plates can be sandwiched between the two cutter bases. A roller wheel is sandwiched between the two restricting holes of the two supporting plates. The upper portion of the cutter plate is provided with a cutting blade, and the lower portion of the cutter plate is provided with a positioning slot. An outer edge of the cutter plate is formed with a driven rack oriented to correspond to the positioning slot. The lower portion of the cutter plate is further provided with a fixing portion corresponding to the elongate slot of the cutter base. A pull lever is connected to the fixing portion of the cutter plate. One end of the operating arm is provided with a pivotal hole, and an arc-shaped driving toothed edge is formed on this end of the operating arm by using the pivotal hole as a center of circle. The other end of the operating arm is connected to an operating handle. The two cutter bases face each other in such a manner that the positioning holes of one cutter base are aligned with those of the other cutter base, thereby forming an accommodating space therebetween. The anvil and the two supporting plates are sandwiched between the two cutter bases. The anvil is fixed to the top sections of the two cutter bases. The restricting hole and the pivotal hole of the supporting plate are respectively aligned with the positioning hole and the pivotal hole of the cutter base, so that the two supporting plates can be fixed between the two cutter bases. Further, the cutter plate and the operating arm are sandwiched between the two supporting plates. The roller wheel is disposed in the positioning slot and sandwiched by the restricting holes of the two supporting plates, so that the cutter blade can move upwards or downwards relative to the supporting plates. The pivotal hole of the operating arm is pivotally connected between the pivotal holes of the two supporting plates in such a manner that the driving toothed edge of the operating arm is drivingly engaged with the driven rack of the cutter plate. The pull lever is fixed to the fixing portion through the elongate slot of the cutter base. With the above structure, the garden shears with a driving mechanism according to the present invention is obtained.

The primary components of the present invention only include two cutter bases, an anvil, a cutter plate and an operating arm. Thus, the present invention has reduced components and costs. Further, the operating handle extends the action arm of the operating arm when the driving toothed edge of the operating arm drives the driven rack of the cutter plate. Thus, the present invention is simple in structure and labor-saving.

Furthermore, the roller wheel is positioned between the restricting holes of the two supporting plates to slide in the positioning slot of the cutter plate. Thus, when the cutter blade is driven by the operating arm to move upwards or downwards, the movement of the cutter plate is smoother due to the rolling of the roller wheel, thereby facilitating the cutting action of the cutter plate.

### BRIEF DESCRIPTION OF THE DRAWINGS

FIG. 1 is a perspective view of an embodiment of the present invention;

FIG. 2 is an exploded perspective view of an embodiment of the present invention;

FIG. 3 is a front view of an embodiment of the present invention;

FIG. 4 is a schematic view of an embodiment of the present invention showing the operating arm pulled open;

FIG. 5 is a schematic view (I) showing another operating state of an embodiment of the present invention; and

FIG. 6 is a schematic view (II) showing another operating state of an embodiment of the present invention.

### DETAILED DESCRIPTION OF THE INVENTION

In order to better understand the objectives, features and effects of the present invention, a detailed description will be made hereinafter with reference to the accompanying drawings.

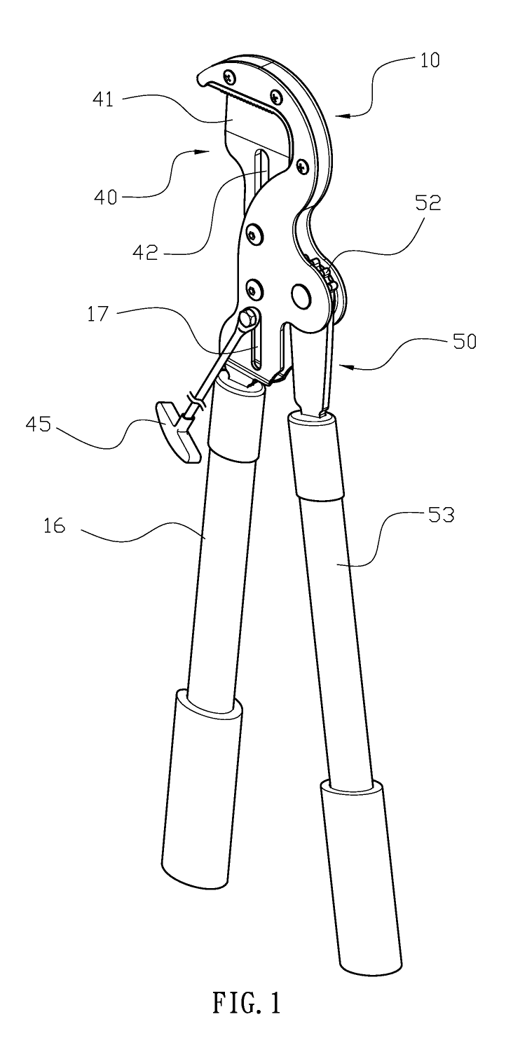

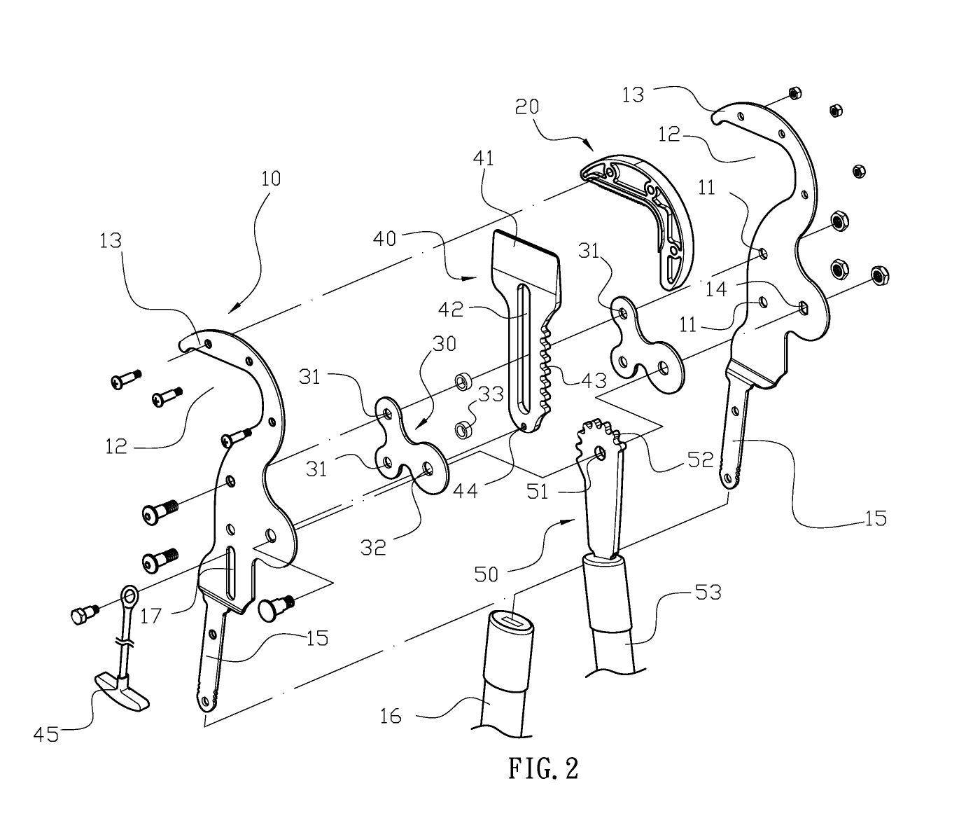

Please refer to FIGS. 1 and 2. An embodiment of the present invention provides a garden shears with a driving mechanism, which includes two cutter bases (10), an anvil (20) cooperating with the cutter bases (10), two supporting plates (30), a cutter plate (40), and an operating arm (50). Each of the two cutter bases (10) is provided with at least two positioning holes (11) disposed in its respective central region. The upper portion of the cutter base (10) is shaped to have a lateral opening (12) with a top section (13) located above the lateral opening (12). A side of the cutter base (11) opposite the two positioning holes (11) is formed with a pivotal hole (14). The lower portion of the cutter base (10) is provided with a connecting section (15). The connecting section (15) is inserted into a handle (16) and fixed thereto. One of the cutter bases (10) is provided with an elongate slot (17) between the positioning holes (11) and the connecting section (15). The anvil (20) is fixed between the top sections (13) of the two cutter bases (10). Each of the two supporting plates (30) is provided with a restricting hole (31) and a pivotal hole (32). When the restricting hole (31) and the pivotal hole (32) of the supporting plate (30) are aligned with the positioning hole (11) and the pivotal hole (14) of the cutter base (10), the two supporting plates (30) can be sandwiched between the two cutter bases (10). A roller wheel (33) is sandwiched between each of the two restricting holes (31) of the two supporting plates (30). The upper portion of the cutter plate (40) is provided with a cutting blade (41), and the lower portion of the cutter plate (40) is provided with a positioning slot (42). An outer edge of the cutter plate (40) is formed with a driven rack (43) oriented to correspond to the positioning slot (42). The lower portion of the cutter plate (40) is further provided with a fixing portion (44) corresponding to the elongate slot (17) of the cutter base (10). A pull lever (45) is fixedly connected to the fixing portion (44) of the cutter plate (40). One end of the operating arm (50) is provided with a pivotal hole (51), and an arc-shaped driving toothed edge (52) is formed on this end of the operating arm (50) using the pivotal hole (51) as a center of circle. The other end of the operating arm (50) is connected to an operating handle (53).

With reference to FIGS. 1 and 2, the assembly of the present invention is described as follows. The two cutter bases (10) face each other in such a manner that the positioning holes (11) of one cutter base (10) are aligned with those of the other cutter base (10), thereby forming an accommodating space there between. The anvil (20) and the two supporting plates (30) are sandwiched between the two cutter bases (10) and fixed there between by screws and nuts. The anvil (20) is fixed to the top sections (13) of the two cutter bases (10). The restricting holes (31) and the pivotal hole (32) of each supporting plate (30) are respectively aligned with the positioning holes (11) and the pivotal hole (14) of the cutter base (10), so that the two supporting plates (30) can be fixed between the two cutter bases (10). Further, the cutter plate (40) and the operating arm (50) are sandwiched between the two supporting plates (30). The roller wheels (33) are disposed in the positioning slot (42) and sandwiched by the restricting holes (31) of the two supporting plates (30), so that the cutter blade (40) can move upwards or downwards relative to the supporting plates (30). The pivotal hole (51) of the operating arm (50) is pivotally connected between the pivotal holes (32) of the two supporting plates (30) in such a manner that the driving toothed edge (52) of the operating arm (50) is drivingly engaged with the driven rack (43) of the cutter plate (40). A screw element is disposed through the pull lever (45) and the elongate slot (17) of the cutter base (10) and fixed to the fixing portion (44), thereby fixing the pull lever (45) to the fixing portion (44) of the cutter plate (40). With the above structure, the garden shears with a driving mechanism according to the present invention is obtained.

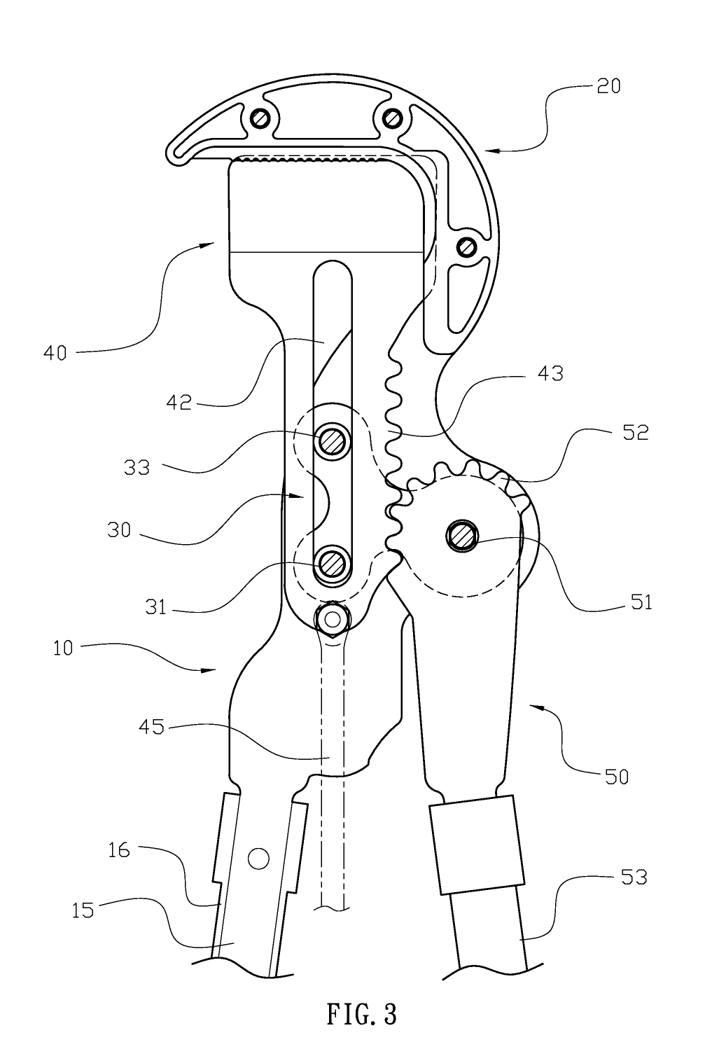

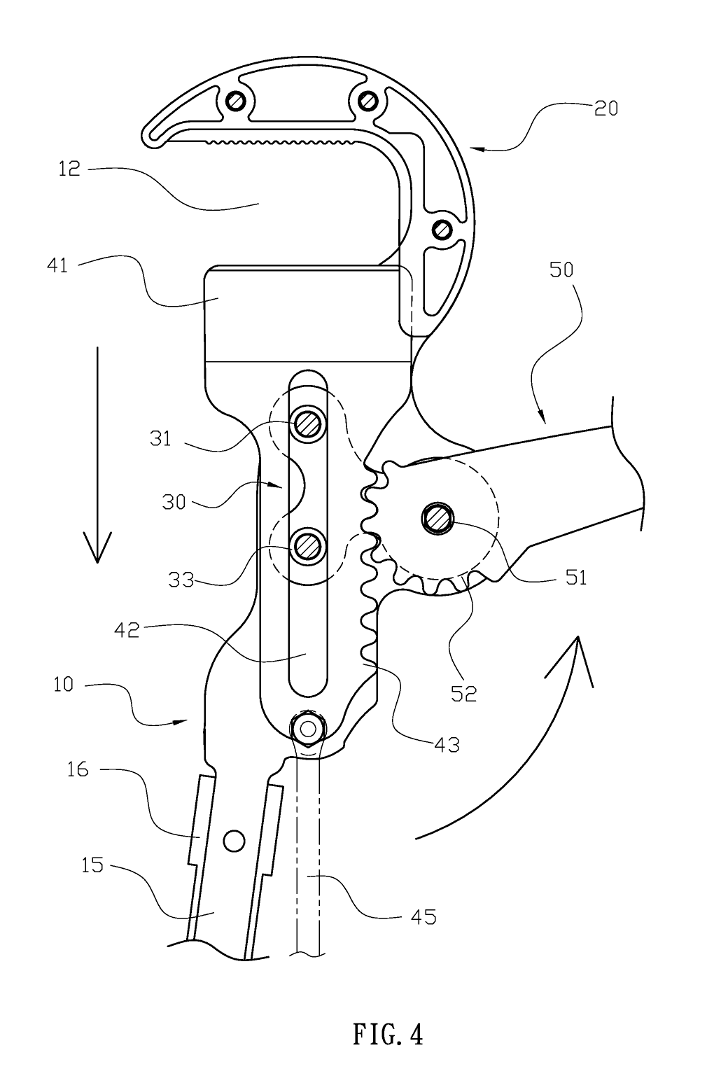

With reference to FIGS. 3 and 4, the operation of an embodiment of the present invention is described as follows. When the embodiment garden shears are in an original state, the operating arm (50) approaches the handle (16) connected to the lower portions of the cutter bases (10). The operating arm (50) forces the cutter plate (40) to move upwards to abut against the anvil (20). When a user intends to use the garden shears for pruning an article such as a branch or a gardening material, the user holds the operating handle (53) and pulls open the operating arm (50) away from the handle (16). As a result, the driving toothed edge (52) of the operating arm (50) drives the driven rack (43) of the cutter plate (40) to move downwards. With the roller wheels (33) rolling in the positioning slot (42), the downward movement of the cutter plate (40) is smooth. At this time, the lateral openings (12) of the two cutter bases (10) are uncovered, so that the user can put the article (such as the branch or gardening material) to be pruned into the lateral openings (12). Then, the user holds the operating handle (53) to force the operating arm (50) to approach the handle (16), so that the cutter plate (40) is driven to move upwards with the cutting blade (41) abutting the anvil (20) again, thereby cutting off the article put in the lateral openings (12).

After the article is cut off, the user repeats to pull open the operating arm (50) away from the handle (16), so that the cutter plate (40) is driven to move downwards to uncover the lateral openings (12). Thus, the pruning action can be continuously performed.

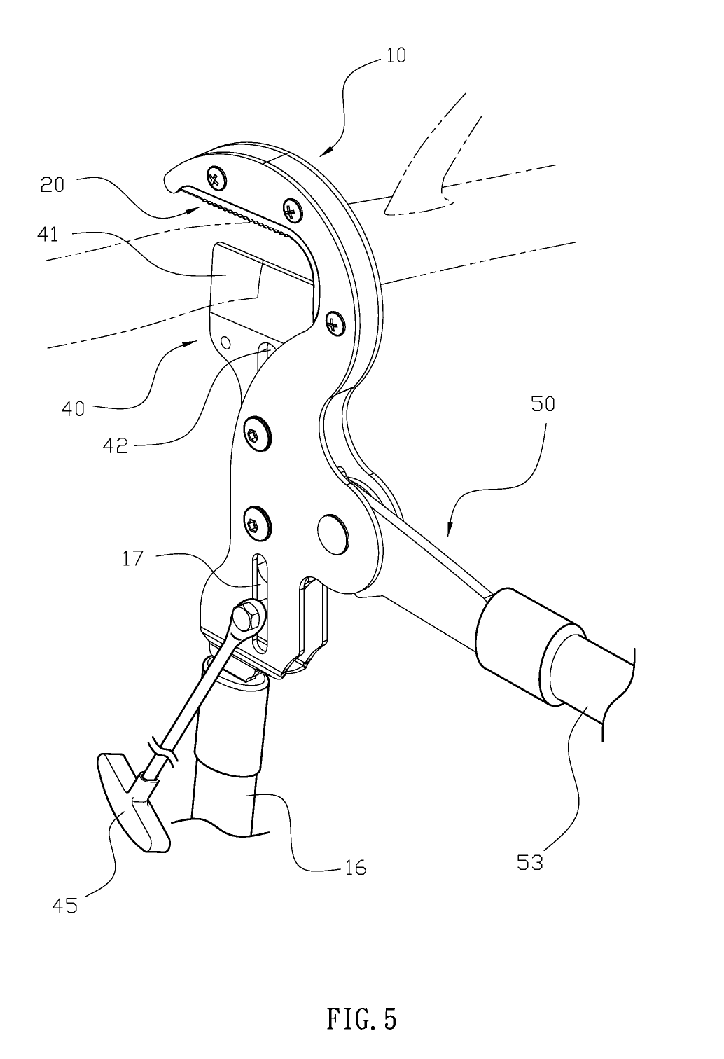

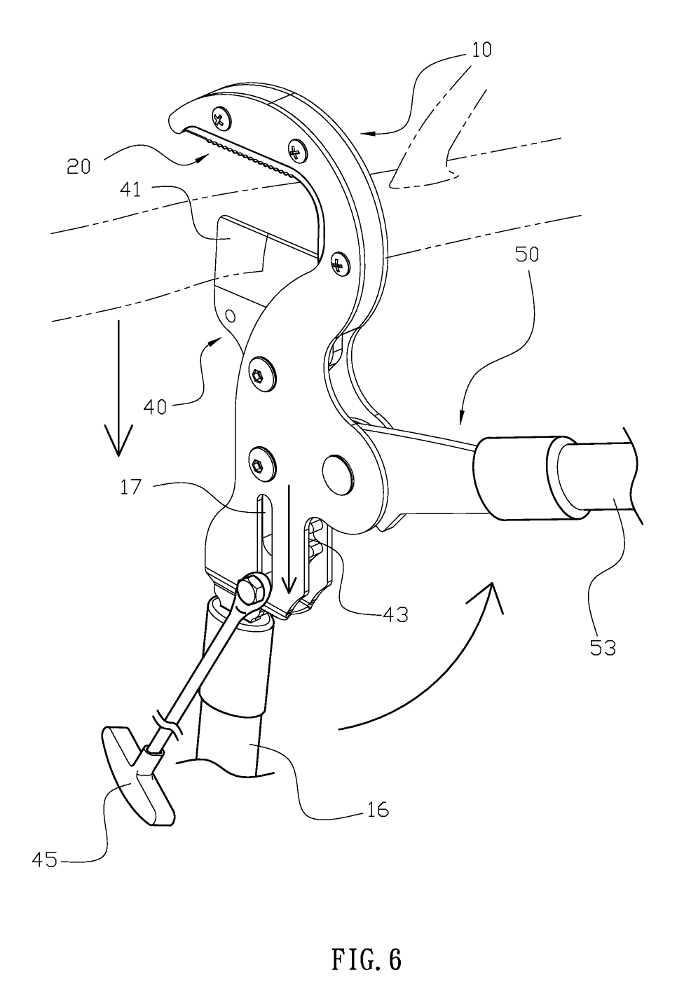

Please refer to FIGS. 5 and 6. In some cases, the branches or the gardening materials are so thick and tough that the cutter plate (40) may be jammed without cutting them off completely. In order to remove the jammed cutter plate (40) from the article, the user has to exert a large force on the operating handle (53) to pull open the operating arm (50) away from the handle (16), which is not easy due to the jamming of the cutter plate (40). Thus, according to an embodiment of the present invention, the pull lever (45) is designed for this purpose. The user pulls the pull lever (45) downwards, so that the cutter plate (40) fixedly connected to the pull lever (45) can be pulled downwards directly and the operating arm (50) is driven to separate from the handle (16). At this time, the user can remove the article from the lateral openings (12) to perform the next pruning action.

The present invention has the following advantageous features:

(I) The primary components of the present invention include only two cutter bases (10), an anvil (20), a cutter plate (40) and an operating arm (50). Thus, the present invention has reduced components and costs. Further, the operating handle (53) extends the action arm of the operating arm (50) when the driving toothed edge (52) of the operating arm (50) drives the driven rack (43) of the cutter plate (40). Thus, the present invention is simple in structure and provides labor-saving benefits; and

(II) The roller wheels (33) positioned between the restricting holes (31) of the two supporting plates (30) slide in the positioning slot (42) of the cutter plate (40). Thus, when the cutter blade (40) is driven by the operating arm (50) to move upwards or downwards, the movement of the cutter plate (40) is smooth due to the rolling of the roller wheels (33), thereby facilitating the cutting action of the cutter plate (40).

According to the above, the present invention really demonstrates industrial applicability, novelty and inventive steps, and thus conforms to the requirements for an invention patent.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A garden shears with a driving mechanism, including:
at least two cutter bases each having at least two positioning holes near a respective central region, an upper portion of each cutter base being formed with a lateral opening and a top section located above the lateral opening, a side of each cutter base opposite the two positioning holes having a pivotal hole, a lower portion of each cutter base being provided with a connecting section, the connecting section being inserted into a handle and fixed thereto, at least one of the cutter bases being provided with an elongate slot between the positioning hole and the connecting section;
an anvil fixed between the top sections of the two cutter bases;
at least two supporting plates each having a restricting hole and a pivotal hole to correspond to the positioning hole and the pivotal hole of the cutter bases respectively, the two supporting plates being sandwiched between the two cutter bases, at least a roller wheel being sandwiched between the restricting holes of the two supporting plates;
a cutter plate having a cutting blade on an upper portion thereof and a positioning slot on a lower portion thereof, an outer edge of the cutter plate being formed with a driven rack disposed to correspond to the positioning slot, the lower portion of the cutter plate being further provided with a fixing portion corresponding to the elongate slot of the cutter base, a pull lever being fixedly connected to the fixing portion; and
an operating arm having a pivotal hole at an one end and an arc-shaped driving toothed edge formed on this end by using the pivotal hole as a center of a circle, the other end of the operating arm being connected to an operating handle;
wherein the two cutter bases face each other in such a manner that the positioning holes of one cutter base are aligned with those of the other cutter base to thereby form an accommodating space there between, the anvil and the two supporting plates are fixedly sandwiched between the two cutter bases, the anvil is fixed to the top sections of the two cutter bases, the restricting hole and the pivotal hole of the supporting plate are respectively aligned with the positioning hole and the pivotal hole of the cutter base, the cutter plate and the operating arm are sandwiched between the two supporting plates, the roller wheel is disposed in the positioning slot and sandwiched by the restricting holes of the two supporting plates, the pivotal hole of the operating arm is pivotally connected between the pivotal holes of the two supporting plates in such a manner that the driving toothed edge of the operating arm is drivingly engaged with the driven rack of the cutter plate, and the pull lever is fixed to the fixing portion through the elongate slot of the cutter base.
